(19) United States
(12) Patent Application Publication
(10) Pub. No.: US 2010/0021258 A1
(43) Pub. Date: Jan. 28, 2010

(54) AIR ROLL UNIT FOR CONTAINER CAR

(75) Inventor: SANG-HYUN KIM, Ichon-si (KR)

Correspondence Address: Jae Y. Park, Kile, Goekjian, Reed & McManus, PLLC, 1200 New Hampshire Ave. NW, Suite 570, Washington, DC, 20036, US

(73) Assignee: HYUNGJAE INDUSTRY CO., LTD., Ichon-si (KR)

(21) Appl. No.: 12/497,625

(22) Filed: Jul. 3, 2009

(30) Foreign Application Priority Data
Jul. 25, 2008 (KR) 10-2008-0073036

(51) Int. Cl. B65G 13/00

(52) U.S. Cl. 410/92

(57) ABSTRACT

The present invention relates to an air roll unit for container car, and more particularly to, a container car, characterized in comprising: a main frame having a rail formed by longitudinal direction, and a joint formed on both sides; a tube inserted into the rail of the main frame with an air nozzle on both ends; a roll plate fixed on the top of the tube; and a connection frame pressedly fixed to the rail of the main frame neighbored and combined into one end of the roll plate. According to the present invention as above, manufacturing costs and terms can be relatively reduced by enabling to unify a baseplate and a roll plate and extend the adjoining baseplate and roll plate.

### TECHNICAL FIELD

The present invention relates to an air roll unit for container car, and more particularly, to an air roll unit for container car which relatively reduces manufacturing costs and terms by enabling to unify a baseplate and a roll plate and extend the adjoining baseplate and roll plate.

### BACKGROUND

Generally, a container car, which indicates a vehicle carrying containers, comprises a cabin installed on the front side; a frame built on the back side of the cabin to load containers; and a baseplate formed on the upper side of the frame to load containers.

FIG. 1 is a sectional diagram representing a baseplate of a previous container car, and the constitution of FIG. 1 is explained as follows.

The baseplate (100) of the container car whose a plurality of grooves (101) are formed by longitudinal direction is characterized by including a tube (200), extended by air supplied in the grooves (101), and a roll plate (300) which enables to go up and down by a plurality of rollers (301) formed on the top of the tube (200).

Further, the tube (200) is placed with air supply separately installed in the car, and the air supply is constituted with an air compressor, an air tank, and a directional control valve.

Accordingly, in case that containers are loaded in the container car, structured as above, first, the tube (200) is extended with air supplied in the tube (200) installed in the groove (101) of the baseplate (100); the roll plate (300) fixed on the top of the tube (200) of the groove (101) is risen; and then, containers can be loaded on the front side by moving containers to the front side with the roller (301) fixed in the roll plate (300).

However, since previous roll plates were formed in length same as one of the container car, the problem that manufacturing costs and terms are increased has been occurred.

### DETAILED DESCRIPTION OF THE INVENTION

### Technical Problem

To accomplish the above object, the present invention is directed to a container car, characterized in comprising: a main frame having a rail formed by longitudinal direction, and a joint formed on both sides; a tube inserted into the rail of the main frame with an air nozzle on both ends; a roll plate fixed on the top of the tube; and a connection frame pressedly fixed to the rail of the main frame adjoined and combined into one end of the roll plate.

Here, the roll plate consists of a U-shaped bracket to be inserted into the rail of the main frame; a plurality of rotation rollers installed for top rotation of the bracket; and a rectangular board-shaped cover fixedly built on the top of the rail of the main frame with a hole for roller placed in the position corresponding to the rotation roller.

Further here, the [symbol] -shaped connection frame is welded and fixed to one end of the bracket of the roll plate, and inside this spot, the air nozzle of the tube is interconnected to the air nozzle of the adjacent tube.

### EFFECTS

According to the air roll unit for container car of the present invention, constituted as above, it has an advantage in which manufacturing costs and terms can be relatively reduced by enabling to unify a baseplate and a roll plate and extend the adjoining baseplate and roll plate.

### Types for Execution of the Invention

Hereinafter, an explanation of a structure of the system for managing social brokering services in an online network according to the present invention will be given with reference to the attached drawings.

A detailed explanation on the known functions and configurations related to this invention will be avoided for the brevity of the description. And, the terms as will be mentioned below are used by the functions defined in this invention, which is of course varied in accordance with the intension or rules of a user or operator. Therefore, the definition of the terms should be based upon the contents of the description of the invention.

FIG. 2 is a stereoscopic diagram representing the constitution of an air roll unit for container car according to the present invention; FIG. 3 is a stereoscopic disassembly diagram representing the constitution of the air roll unit for container car according to the present invention; FIG. 4 is a stereoscopic diagram representing the constitution of the air roll unit for container car according to the present invention; FIG. 5 is a stereoscopic diagram specifically representing the combination of the air roll unit for container car according to the present invention; and FIG. 6 is a partial diagram of the FIG. 4.

Referring to FIGS. 2 to 6, the air roll unit for container unit (10) according to the present invention comprises a main frame (20), a tube (30), a roll plate (40), and a connection frame (50).

First, the main frame (20) is formed by constant length (approximately 1 to 2 meters); the aluminium metal rail (21) is formed by longitudinal direction; and joints (23) are built on both sides. Here, the joints (23) are organized by interconnecting to generally-combined neighboring main frame, or coupling to the main frame again after installing a separate frame and placing the separate frame with a constant gap (approximately 1 meter).

In addition, the synthetic resin tube (30) is inserted into the rail (21) of the main frame (20), equipped with the air nozzle (31) on both ends. Here, the tube (30) is built shorter than the main frame (20) so that the connection frame (50), explained below, can be inserted into the rail (21) of the main frame (20); and the air nozzle (31) is built by length to be linked to the air nozzle of the adjoining tube. Further here, the tube (30) is connected to air supply (not illustrated) separately installed in the container car, and the air supply is constituted with an air compressor, an air tank, a directional control valve, etc.

Furthermore, the roll plate (40) consists of a U-shaped bracket (41) to be inserted into the rail (21) of the main frame (20); a plurality of rotation rollers (43) installed for top rotation of the bracket (41); and a rectangular board-shaped cover (45) fixedly built on the top of the rail (21) of the main frame (20) with a hole for roller (47) placed in the position corresponding to the rotation roller (43).

the [symbol] -shaped connection frame (50) is welded and fixed to one end of the bracket (41) of the roll plate (40), and inside this spot, the air nozzle (31) of the tube (30) is interconnected to the air nozzle of the adjacent tube.

Hereinafter, the assembling procedures and operations of the air roll unit for container car according to the present invention will be given with reference to the attached drawings.

FIGS. 7a and 7b are explanation diagrams representing the operation status of the air roll unit for container car according to the present invention.

First, the baseplate of the container car is formed by using the main frame (20). After placing the tube (30) to the rail (21) of the main frame (20) and installing the roll plate (40) on the top of the tube (30), the cover (45) of the roll plate (40) is fixed to the main frame (20).

Then, the connection frame (50) is welded to one end of the bracket (41) of the roll plate (40).

After assembling one end of the main frame (20), i.e., the main frame close to the position where the connection frame (50) is built, throughout such processes in the state that the main frame (20) is fixed to the container car as above, the air nozzle (31) of the tube (30) is interconnected to the air nozzle of the neighboring tube inside the connection frame (50), and the rail of the adjacent main frame is pressedly fixed by using the connection frame (50).

Then, the main frame (20) is built as designed length by the repeated procedure as above.

Next, after installing a separate frame on both sides of the main frame (20) again and placing the separate frame by constant gap (approximately 1 meter), the baseplate is completed by linking the separate frame to the main frame again.

If the installation is completed as above, the tube formed in each main frame is coupled to the air supply.

If air is provided in the air supply in such condition, the tube (30) is expanded in the rail (21).

Then, the bracket (41) of the roll plate (40) next to the tube (30) is ascended, and due to this, the rotation roller (43) is protruded through the hole for roller (47) of the cover (45). Also, the container may be moved by using the protruded rotation roller (43). The present invention can be variously modified and embodied by several types of forms, and particular illustrative embodiments are merely described in the detailed description of the invention. However, it should be appreciated in such a manner that the present invention is not limited as a particular type, mentioned in the detailed description, but rather it comprises all modified materials, equal materials, and substitutes within the spirit and the range of the present invention, defined by the enclosed claims herewith.

### BRIEF DESCRIPTION OF THE DRAWINGS

FIG. 1 is a sectional diagram representing a baseplate of a previous container car;

FIG. 2 is a stereoscopic diagram representing the constitution of an air roll unit for container car according to the present invention;

FIG. 3 is a stereoscopic disassembly diagram representing the constitution of the air roll unit for container car according to the present invention;

FIG. 4 is a stereoscopic diagram representing the constitution of the air roll unit for container car according to the present invention;

FIG. 5 is a stereoscopic diagram specifically representing the combination of the air roll unit for container car according to the present invention;

FIG. 6 is a partial diagram of the FIG. 4; and

FIG. 7a and FIG. 7b are explanation diagrams representing operation status of the air roll unit for container car according to the present invention.

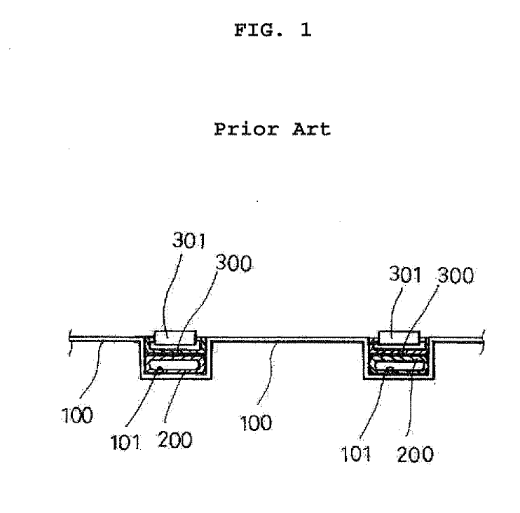

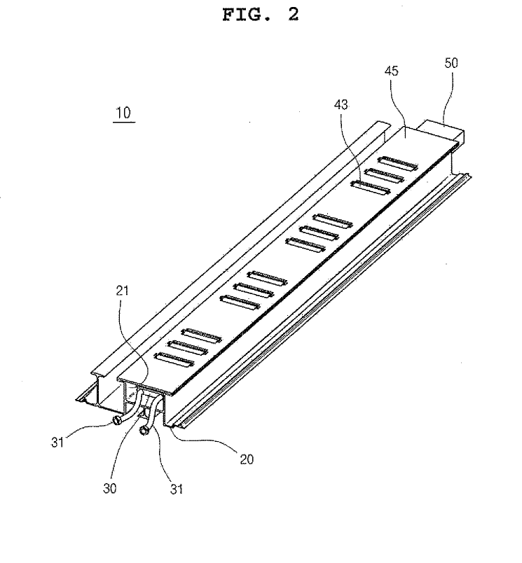

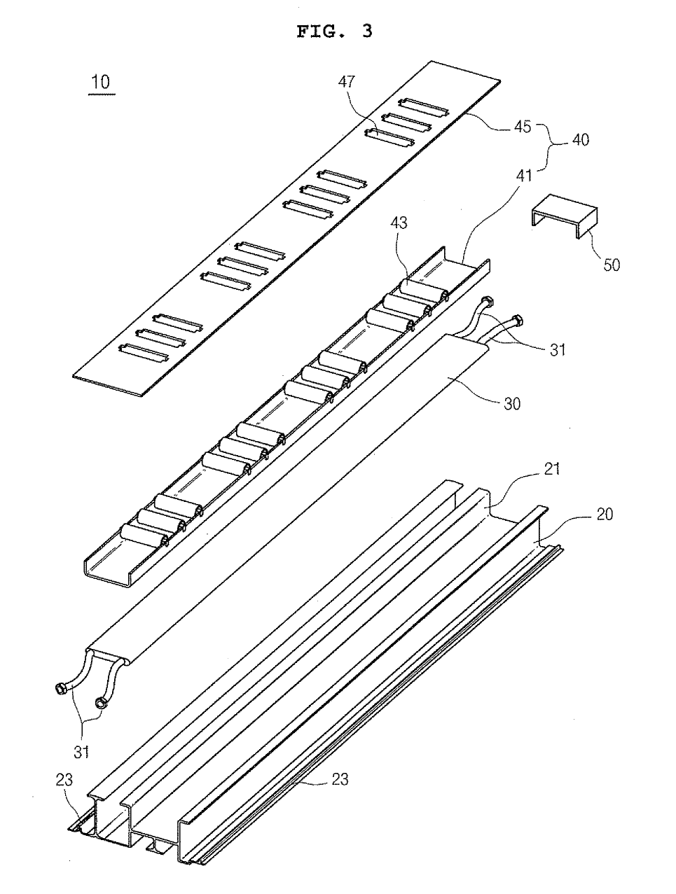

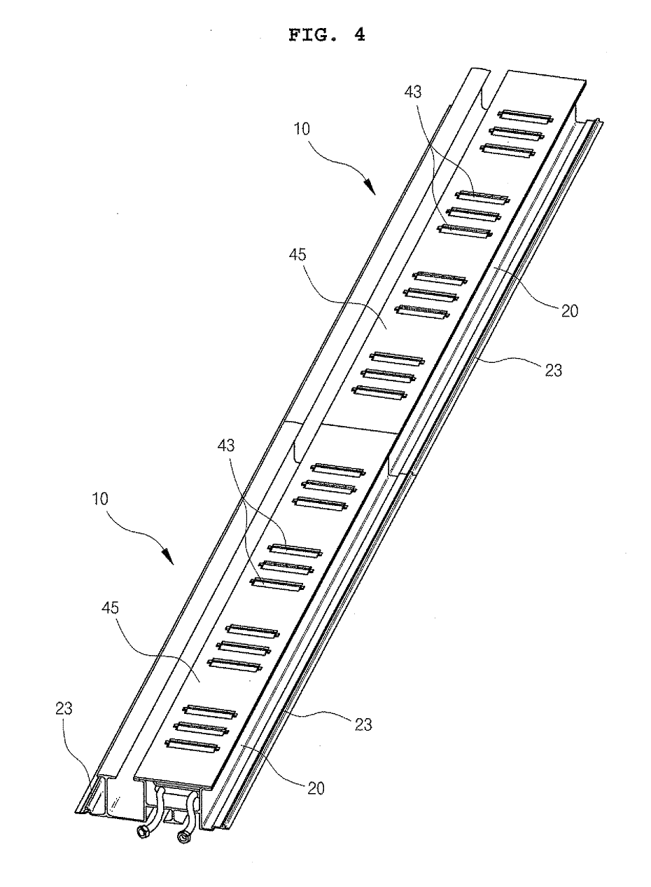

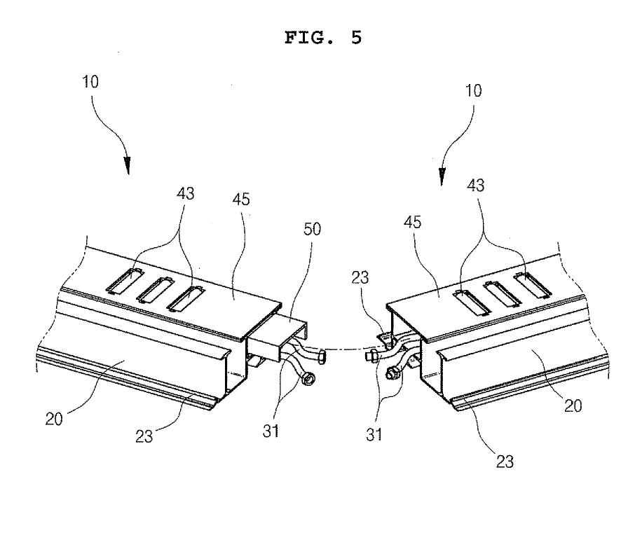

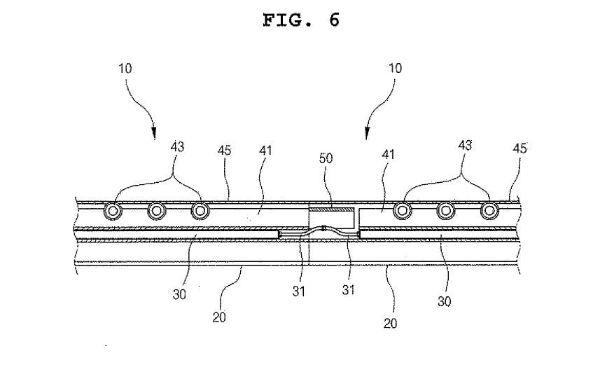

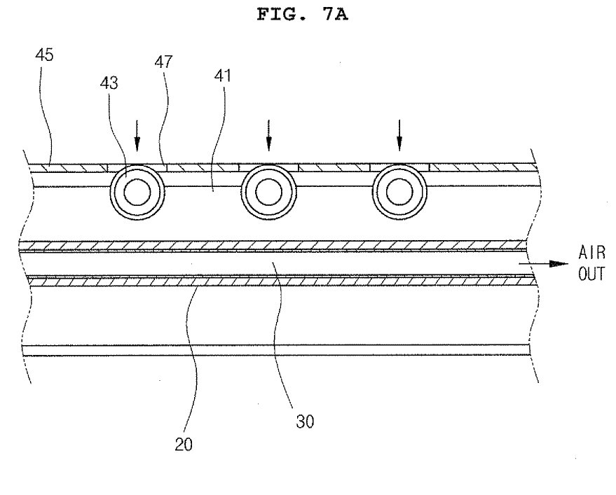

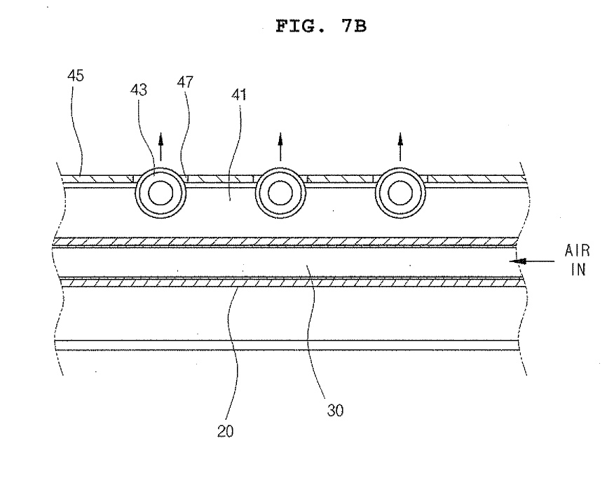

### EXPLANATIONS ON REFERENCE NUMERALS OF MAIN PARTS OF DRAWINGS

20: main frame
21: rail
30: tube
31: air nozzle
40: roll plate
41: bracket
43: rotation roller
45: cover
47: hole for roller
50: connection frame

What is claimed is:

1. An air roll unit for container car, comprising: a main frame having a rail formed by longitudinal direction, and a joint formed on both sides; a tube inserted into the rail of the main frame with an air nozzle on both ends; a roll plate fixed on the top of the tube; and a connection frame pressedly fixed to the rail of the main frame adjoined and combined into one end of the roll plate.

2. The air roll unit for container car according to claim 1, wherein the roll plate consists of a U-shaped bracket to be inserted into the rail of the main frame; a plurality of rotation rollers installed for top rotation of the bracket; and a rectangular board-shaped cover fixedly built on the top of the rail of the main frame with a hole for roller placed in the position corresponding to the rotation roller.

3. The air roll unit for container car according to claim 2, wherein the [symbol] -shaped connection frame is welded and fixed to one end of the bracket of the roll plate, and inside this spot, the air nozzle of the tube is interconnected to the air nozzle of the adjacent tube.
